(19) United States
(12) Patent Application Publication
(10) Pub. No.: US 2020/0034101 A1
(43) Pub. Date: Jan. 30, 2020

(54) DATA DISPLAYING METHOD AND ELECTRONIC DEVICE

(71) Applicant: Zhangyue Technology Co., Ltd., Beijing (CN)

(72) Inventors: Yalei Wang, Beijing (CN); Xingang Chen, Beijing (CN); Qirui Hou, Beijing (CN)

(73) Assignee: Zhangyue Technology Co., Ltd., Beijing (CN)

(21) Appl. No.: 16/497,874

(22) PCT Filed: Jun. 20, 2017
(86) PCT No.: PCT/CN2017/089259

§ 371 Date: Sep. 26, 2019

(30) Foreign Application Priority Data
Mar. 31, 2017 (CN) 201710208903.2

(51) Int. Cl. G06F 3/14; G06F 16/25; G06F 16/176; G06F 9/54; G06F 3/0484

(52) U.S. Cl. CPC G06F 3/1446; G06F 16/252; G06F 3/0484; G06F 9/54; G06F 16/176

(57) ABSTRACT

Disclosed are a data displaying method and an electronic device. The data displaying method includes: setting a first application having a first display characteristic and a second application having a second display characteristic; displaying display data in the shared database on a first screen of the electronic device with the first display characteristic; and displaying the display data in the shared database on a second screen of the electronic device with the second display characteristic.

### CROSS-REFERENCE TO RELATED APPLICATIONS

This application is a national stage of International Application No. PCT/CN2017/089259 filed Jun. 20, 2017, which claims priority to Chinese Patent Application No. 201710208903.2, titled “DATA DISPLAYING METHOD, DATA DISPLAYING DEVICE AND ELECTRONIC DEVICE”, filed Mar. 31, 2017, the entire contents of which are incorporated herein by reference.

### TECHNICAL FIELD

The disclosure relates to the technical field of data display, and particularly to display technology of specific data in an electronic device having two screens.

### BACKGROUND

With the development of smart phones, there are increasing personalized differences between the smart phones. A two-screen cell phone is typical in many personalized cell phones. The common two-screen cell phone is generally provided with two screens including a primary touch screen on the front side of the phone and a secondary touch screen on the back side of the phone. In one case, the area of the primary touch screen is larger than the area of the secondary touch screen, and a part of functions and usage of the phone on the primary touch display are completely implemented on the secondary touch screen. In this way, a user can perform operations on the secondary touch screen with one hand to control operations of the phone, so as to answer the phone, hang up the phone or perform other operations. As another ease, an LCD primary color screen having a high resolution may he provided on the front side of the phone, and an E-ink electronic paper screen may be provided on the back side of the phone. As compared with the LCD primary display, the E-ink electronic paper display has the characteristics of ultra-thin, ultra-light, ultra-power-saving, ultra-high visibility under sunlight and the like.

It has been found by the inventor that the two screens on the front side and the back side of the two-screen cell phone have different display characteristics. The same content may be displayed differentially on the primary screen and the secondary screen due to the different display characteristics, and even some content can be displayed only on the primary screen, and cannot be displayed on the secondary screen. It is desirable for the user to, when using the two-screen cell phone, take full advantage of the two-screen cell phone and try to avoid the inconvenience.

Therefore, a display control solution for the two-screen cell phone having different display characteristics and other electronic devices is required.

### SUMMARY

In view of this, a data displaying method and an electronic device are provided according to the embodiments of the disclosure, to at least partially solve the problems in the prior art.

In an aspect, a data displaying method applied to an electronic device is provided according to an embodiment of the disclosure, which includes: setting a first application having a first display characteristic and a second application having a second display characteristic; connecting the first application and the second application to a shared database, respectively, the shared database storing display data; displaying the display data in the shared database on a first screen of the electronic device with the first display characteristic by using the first application; and displaying the display data in the shared database on a second screen of the electronic device with the second display characteristic by using the second application.

In a second aspect, an electronic device is further provided according to an embodiment of the present disclosure, which includes: one or more processors; and a memory; wherein one or more instructions are stored in the memory, and when executed by the one or more processors, the one or more instructions cause the one or more processors to: set a first application having a first display characteristic and a second application having a second display characteristic; connect the first application and the second application to a shared database, respectively, the shared database storing display data; display the display data in the shared database on a first screen of the electronic device with the first display characteristic by using the first application; and display the display data in the shared database on a second screen of the electronic device with the second display characteristic by using the second application.

In a third aspect, a non-transitory computer readable memory medium is further provided according to an embodiment of the disclosure. Computer instructions are stored in the non-transitory computer readable memory medium, and are used to enable a computer to execute the data displaying method described in the first aspect.

With the data displaying method, the electronic device, the non-transitory computer readable memory medium and the computer program according to the embodiments of the disclosure, the first application having the first display characteristic and the second application having the second display characteristic are set, and the first application and the second application are used to control content display on the first screen and the second screen of the electronic device, respectively, which solves a problem that different screens of the same electronic device cannot be compatible with each other in display due to different display characteristics. The first application and the second application can acquire display content from the same shared database, which ensures consistency among the content.

### BRIEF DESCRIPTION OF THE DRAWINGS

In order to more clearly illustrate the technical solution in the embodiments of the disclosure, in the following, drawings required in the description of the embodiments will be introduced simply. Apparently, the drawings in the following description show only some embodiments of the disclosure. For those skilled in the art, other drawings can also be obtained according to the provided drawings without any creative work.

FIG. 1 is a schematic flow chart of a data displaying method according to an embodiment of the disclosure.

FIG. 2 is a schematic flow chart of displaying, by a second application, the content of the first application based on inter-process communication according to an embodiment of the disclosure.

FIG. 3 is a schematic flow chart of switching the content of the first application and the content of the second application based on a switch key according to an embodiment of the disclosure.

FIG. 4 is a schematic flow chart of displaying, by the second application, the compatible reading texts according to an embodiment of the disclosure.

FIG. 5 is a schematic block diagram of a data displaying device according to an embodiment of the disclosure.

FIG. 6 is a schematic block diagram of another data displaying device according to an embodiment of the disclosure.

FIG. 7 is a schematic block diagram of another data displaying device according to an embodiment of the disclosure.

FIG. 8 is a schematic structural diagram of an electronic device according to an embodiment of the disclosure.

### DETAILED DESCRIPTION

The embodiments of the disclosure are described in detail below in conjunction with the drawings.

It should be noted that the described embodiments are only a part rather than all of the embodiments of the disclosure. On basis of the embodiments of the disclosure, all other embodiments obtained by those skilled in the art without any creative labor fall within the protection scope of the disclosure.

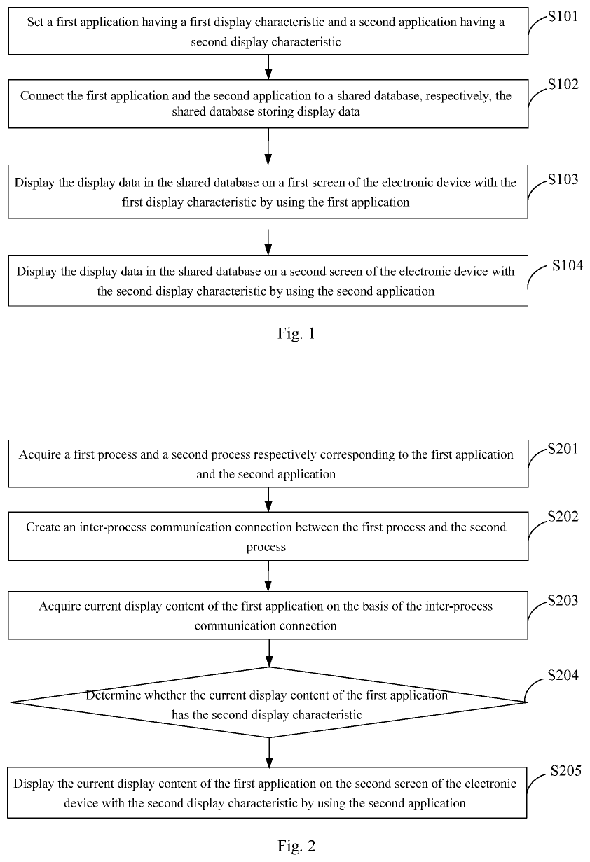

FIG. 1 shows a data displaying method according to an embodiment of the disclosure. With reference to FIG. 1, the method includes steps S101 to S104.

In step S101, a first application having a first display characteristic and a second application having a second display characteristic are set.

With taking the Android system as an example, a first application and a second application having a reading function may be installed and integrated as an APK installation package in the Android system. Reading font size adjusting, reading style setting, reading theme customizing, reading progress jumping and other operations can be supported in the first application and the second application. Besides, keyword searching, automatically page turning special effects of page turning, bookmarking, sharing with friends, downloading e-books online and other operations are also supported on an interactive interface of the first application and the second application.

The first application has the first display characteristic, and the first display characteristic matches with a display characteristic of a first screen of the electronic device. With the first display characteristic, more colors (for example, 24-bit true color) are used for indicating the display content, a higher screen resolution is supported, content in all data formats can be displayed, and a higher screen refresh frequency is supported. Display of a general LCD screen can be supported with the first display characteristic.

The second application has the second display characteristic, and the second display characteristic matches with a display characteristic of a second screen of the electronic device. With the second display characteristic, less colors (for example, 16 gray scales) are used for indicating the display content, a lower screen resolution is supported, content in only a part of data formats is displayed mostly, and a lower screen refresh frequency is used. Display of a common E-ink screen can be supported with the second display characteristic.

After being installed in the electronic device such as a cell phone, the first application and the second application can be started in a manner of clicking by the user or other triggering manner, and then perform respective display functions.

In step S102, the first application and the second application are respectively connected with a shared database in which the display data is stored.

Content to be displayed by the first application and the second application may be data which generated by the operation of the system, or may be data pre-stored in the shared database. With taking the common e-book as an example, display data of the e-book in the format of txt, html, chin, pdf, epub, mobi may be stored in the shared database. The content of the e-book is stored as a file mostly, and multimedia, chapter format and some book basic information such as book numbering may also be supported in the e-book in the format of html, epub, mobi or the like. The book content is stored as a file in the above formats. For example, an e-book may be stored as a file.

As an implementation, a mysql database may be used as the shared database locally in the electronic device, to store the display content. The first application and the second application are respectively connected with the shared database in which the display data is stored, to ensure consistency between the content of the first application and the content of the second application.

The shared database may be a private database of the first application, and is stored in a data directory of the first application, and the second application may perform read and write operations on the shared database. Optionally, the shared database may also be a private database of the second application, and is stored in a data directory of the second application, and the first application may perform read and write operations on the shared database.

In step S103, the display data in the shared database is displayed on the first screen of the electronic device with the first display characteristic by using the first application.

When user initiates a display operation instruction on an interactive interface of the first application, the first application may retrieve content in the shared database by using a keyword, an index or in other manner. The content of the e-book may be read from the database through a data interface when the corresponding display content is retrieved, and a display file such as an e-book is generated on the basis of a data format of the display content.

In the process of generating the display content in the database as the e-book by the first application, a format of data content is converted by the first application, so that the converted display file can have the first display characteristic. The first display characteristic matches with the first screen. The generated display file is finally displayed on the first screen using the first application.

In step S104, the display data in the shared database is displayed on the second screen of the electronic device with the second display characteristic by using the second application.

When the user initiates a display operation instruction on an interactive interface of the second application, the second application may retrieve content in the shared database using a keyword, an index or in other manner. The content of the e-book may be read from the database through a data interface when the corresponding display content is retrieved, and a display file such as an e-book is generated on the basis of a data format of the display content.

In the process of generating the display content in the database as the e-book by the second application, a format of data content is converted by the second application, so that the converted display file can have the second display characteristic. The second display characteristic matches with the second screen. The generated display file is finally displayed on the second screen using the second application.

The display content in the shared database are loaded and displayed by the first application and the second application, so that the same content can be displayed on different screens of the same electronic device in a matched manner while ensuring consistency of the content on the different screens.

Optionally, during displaying data, the first application may communicate with the second application by a process to display content in the second application, and the second application may communicate with the first application by a process to display content in the first application. With taking a case that the second application displays the content of the first application as an example, with reference to FIG. 2, the data displaying method may further include steps S201 to S205.

In step S201, a first process corresponding to the first application and a second process corresponding to the second application are acquired respectively.

Specifically, information of all currently-run processes may be acquired by ActivityManager, and package names (pkgname) of the first application and the second application being run in each of the processes are acquired. A method provided by a PackageManager class is called directly based on the package names (pkgname), to acquire the processes of the first application and the second application. Exemplary codes are described as follows.

int pid = android.os.Process.myPid( );

| String processName = NULL; | | |
|---|---|---|
| ActivityManager | am | = |

(ActivityManager)this.getSystemService(Context.ACTIVITY_SERVICE);

| | | | |
|---|---|---|---|
| for | (ActivityManager.RunningAppProcessInfo | appProcess | : |

am.getRunningAppProcesses( )){

if(appProcess.pid == pid){

processName = appProcess.processName;
break;

}

}

Besides, PackageName corresponding to the current process may also be acquired by RunningAppProcessInfo, and related information of an application corresponding to the current process is acquired using a getApplicationInfo (packageName, flags) method of the PackageManager class, to further acquire the processes of the first application and the second application.

In step S202, an inter-process communication connection is created between the first process and the second process. The inter-process communication connection is used for acquiring the display data of the first application or the second application.

With taking the Android development system as an example, the inter-process communication connection may be implemented using the AIDL, which is implemented by steps 1) to 4).

In step 1), a *.aidl file is created in the second application. After the aidl file is created, an interface file IDownloadService.java is automatically generated in a gen directory of the project by the system, and an abstract class of Stub is generated in the interface file. The abstract class includes a method defined by the aidl, and further includes some auxiliary method.

In step 2), an interface generated by the aidl file is implemented in the second application. Specifically, the interface and codes of the method for implementing the interface may be implemented by inheriting the Stub of the interface (the aidl interface is implemented in the abstract class of Stub).

In step 3), a Service is created in the second application, and an object for implementing the aidl interface is returned in the onBind (Intent intent) method of the service.

In step 4), the package including the aidl file in the second application and the aidl file are copied into the first application on the client side, and an interface file DownloadService.java is generated synchronously in the gen directory of the first application by the system for the aidl file, and then the first application can communicate with the second application.

In step S203, current display content of the first application is acquired on the basis of the inter-process communication connection.

The current display content of the first application may be acquired by the second application on the basis of the inter-process communication connection.

In step S204, whether the current display content of the first application has the second display characteristic is determined.

Since the second application is used for displaying content on the second screen, whether the data format of the current display content of the first application is compatible with the second application needs to be determined, to display compatible content on the second screen.

In step S205, the current display content of the first application is displayed on the second screen of the electronic device with the second display characteristic by using the second application.

When it is determined in step S204 that the current display content of the first application has the second display characteristic, the current display content of the first application can be displayed on the second screen by using the second application.

During the process, a format of the display content is converted by the second application, so that the converted display content conforms to the second display characteristic.

During step S205, the second application may be also used for acquiring display information corresponding to the current display content of the first application, and the display information corresponding to the current display content of the first application is displayed on the second screen of the electronic device with the second display characteristic.

The display information may include at least one of: ID of a reading file displayed by the first application, and reading progress information of the reading file displayed by the first application. The ID of the reading file and the reading progress information of the reading file may be stored in the database. The ID and the reading progress information of a reading file corresponding to the current display content of the first application which is stored in the shared database may be read from the shared database using the second application.

The display information may further include information displayed on a screen of a display interface of the first application.

With the technical solution according to the embodiment, the content of the first application and the content of the second application can be synchronized with each other, which ensures consistency of the content.

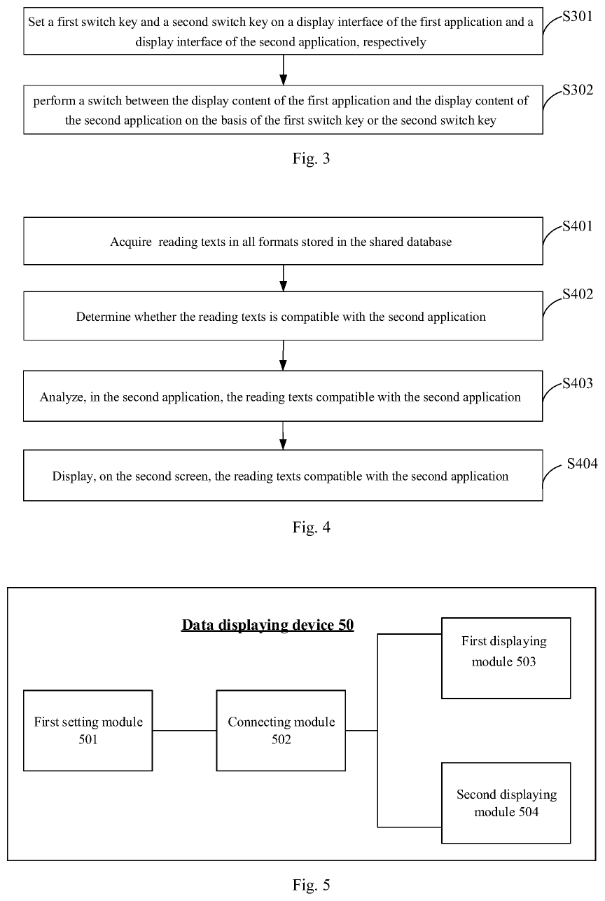

Optionally, a method for performing a switch between the content of the first application and the content of the second application on the basis of a switch key is further provided according to an embodiment of the disclosure. With reference to FIG. 3, the method includes steps S301 and S302.

In step S301, a first switch key and a second switch key are set on a display interface of the first application and a display interface of the second application, respectively.

The first switch key may be set on an interactive interface of the first application, and the second switch key may be set on an interactive interface of the second application. The first switch key and the second switch key may be interactive keys on a software interactive interface, or may also be command keys associated with a physical key of the electronic device.

In step S302, a switch between the content of the first application and the content of the second application is performed on the basis of the first switch key or the second switch key.

When an instruction associated with the first switch key is executed, the content of the first application may be projected to the display interface of the second application, and the first screen is turned off. In practice, the content of the first application may be projected to the display interface of the second application, while the content of the second application is displayed in the first application. The content of the first application and the content of the second application may be the same with each other or different from each other.

A process performed when an instruction associated with the second switch key is executed is similar to the process performed when the instruction associated with the first switch key is executed, which is not described repeatedly here anymore.

With the solution in the embodiment, the switch between the content on the first screen and the content on the second screen can be controlled in a flexible manner.

As an optional implementation, the display data in the shared database includes reading texts in different data formats, when the display data in the shared database is displayed on the first screen of the electronic device with the first display characteristic by using the first application, the first application can analyze the reading texts in all formats stored in the shared database, and display the reading texts in all formats on the first screen.

As another optional implementation, with reference to FIG. 4, when the display data in the shared database is displayed on the second screen of the electronic device with the second display characteristic by using the second application, steps S401 to S404 are executed.

In step S401, the reading texts in all formats stored in the shared database are acquired.

With taking the common e-book as an example, display data of the e-book in the format of txt, html, chm, pdf, epub, mobi may be stored in the shared database. The content of the e-book is stored as a file mostly, and multimedia, chapter format and some book basic information such as book numbering may also be supported in the e-book in the format of html, epub, mobi or the like. The book content is stored as a file in the above formats. For example, an e-book may be stored as a file. In this way, all e-books content and the format of the e-books stored in the database need to be acquired.

In step S402, whether the formats of the reading texts are compatible with the second application is determined.

Since the second application is used for displaying content on the second screen, whether the e-book acquired from the shared database is compatible with the second application is determined. For example, the e-book in the format of html, chm and pdf has a poor display effect on the second screen, thus the e-book in the format of html, chm and pdf needs to be filtered out in display.

In step S403, the reading texts compatible with the second application are analyzed in the second application.

When the reading texts such as the e-book supported by and compatible with the second application are determined in step S402, the compatible reading texts may be analyzed using the second application, to generate content suitable to be displayed on the second screen on the basis of the analyzed reading texts.

In step S404, the reading texts compatible with the second application are displayed on the second screen.

Before the reading texts compatible with the second application are displayed on the second screen using the second application, the data formats of the reading texts are converted. For example, reading texts in the full color format are converted into the reading texts in the gray scale format, to finally display the reading texts in the gray scale format on the second screen.

With the solution according to the embodiment, text patterns compatible with the first application and the second application can be filtered according to compatibility, which improves the display effect of the content on the first screen and the second screen.

FIG. 5 shows a data displaying device according to an embodiment of the present disclosure. With reference to FIG. 5, the data displaying device 50 includes a first setting module 501, a connecting module 502, a first displaying module 503 and a second displaying module 504.

The first setting module 501 is configured to set a first application having a first display characteristic and a second application having a second display characteristic.

With taking the Android system as an example, a first application and a second application having a reading function may be installed and integrated as an APK installation package in the Android system. Reading font size adjusting, reading style setting, reading theme customizing, reading progress jumping and other operations can be supported in the first application and the second application. Besides, keyword searching, automatically page turning special effects of page turning, bookmarking, sharing with friends, downloading e-books online and other operations are also supported on an interactive interface of the first application and the second application.

The first application has the first display characteristic, and the first display characteristic matches with a display characteristic of a first screen of the electronic device. With the first display characteristic, more colors (for example, 24-bit true color) are used for indicating the display content, a higher screen resolution is supported, content in all data formats can be displayed, and a higher screen refresh frequency is supported. Display of a general LCD screen can be supported with the first display characteristic.

The second application has the second display characteristic, and the second display characteristic matches with a display characteristic of a second screen of the electronic device. With the second display characteristic, less colors (for example, 16 gray scales) are used for indicating the display content, a lower screen resolution is supported, content in only a part of data formats is displayed mostly, and a lower screen refresh frequency is used. Display of a common E-ink screen can be supported with the second display characteristic.

After being installed in the electronic device such as a cell phone, the first application and the second application can be started in a manner of clicking by the user or other triggering manner, and then perform respective display functions.

The connecting module 502 is configured to respectively connect the first application and the second application with a shared database in which the display data is stored.

Content to be displayed by the first application and the second application may be data generated during operation of the system, or may be data pre-stored in the shared database. With taking the common e-book as an example, display data of the e-book in the format of txt, html, chm, pdf, epub, mobi may be stored in the shared database. The content of the e-book is stored as a file mostly, and multimedia, chapter format and some book basic information such as book numbering may also be supported in the e-book in the format of html, epub, mobi or the like. The book content is stored as a file in the above formats. For example, an e-book may be stored as a file.

As an implementation, a mysql database may he used as the shared database locally in the electronic device, to store the display content. The first application and the second application are respectively connected with the shared database in which the display data is stored, to ensure consistency between the content of the first application and the content of the second application.

The shared database may be a private database of the first application, and is stored in a data directory of the first application, and the second application may perform read and write operations on the shared database. Optionally, the shared database may also be a private database of the second application, and be stored in a data directory of the second application, and the first application may perform read and write operations on the shared database.

The first displaying module 503 is configured to display the display data in the shared database on the first screen of the electronic device with the first display characteristic by using the first application.

When the user initiates a display operation instruction on an interactive interface of the first application, the first application may retrieve content in the shared database by using a keyword, an index or in other manner. The content of the e-book may be read from the database through a data interface when the corresponding display content is retrieved, and a display file such as an e-book is generated on the basis of a data format of the display content.

In the process of generating the display content in the database as the e-book by the first application, a format of data content is converted by the first application, so that the converted display file can have the first display characteristic. The first display characteristic matches with the first screen. The generated display file is finally displayed on the first screen using the first application.

The second displaying module 504 is configured to display the display data in the shared database on the second screen of the electronic device with the second display characteristic using the second application.

When the user initiates a display operation instruction on an interactive interface of the second application, the second application may retrieve content in the shared database using a keyword, an index or in other manner. The content of the e-book may be read from the database through a data interface when the corresponding display content is retrieved, and a display file such as an e-book is generated on the basis of a data format of the display content.

In the process of generating the display content in the database as the e-book by the second application, a format of data content is converted by the second application, so that the converted display file can have the second display characteristic. The second display characteristic matches with the second screen. The generated display file is finally displayed on the second screen using the second application.

The display content in the shared database are loaded and displayed by the first application and the second application, so that the same content can be displayed on different screens of the same electronic device in a matched manner while ensuring consistency of the content on the different screens.

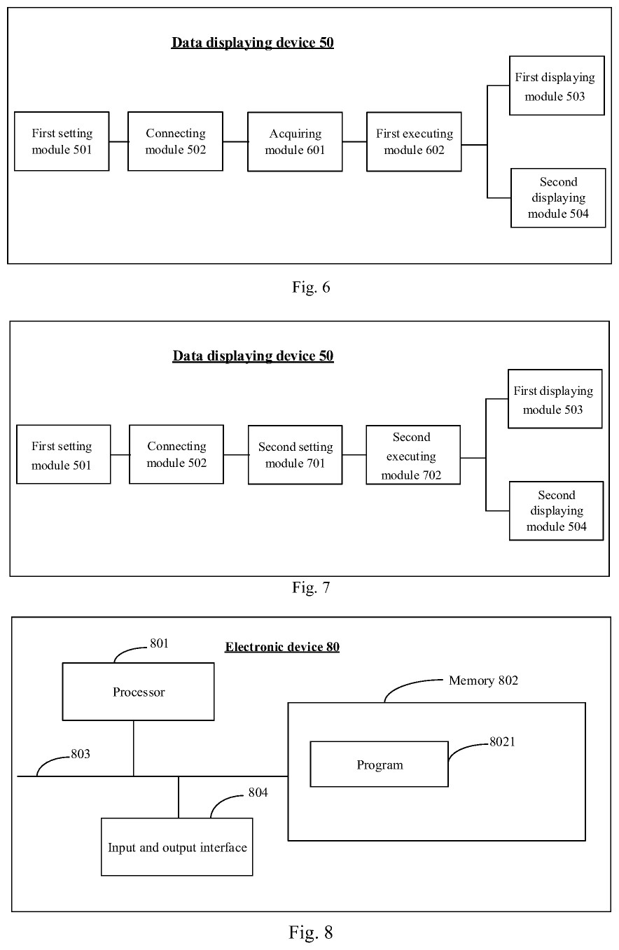

With reference to FIG. 6, the data displaying device 50 further includes: an acquiring module 601 and a first executing module 602.

The acquiring module 601 is configured to acquire a first process and a second process respectively corresponding to the first application and the second application.

The first executing module 602 is configured to create an inter-process communication connection between the first process and the second process. The inter-process communication connection is configured to acquire the content of the first application or the content of the second application.

With reference to FIG. 7, the data displaying device 50 further includes a second setting module 701 and a second executing module 702.

The second setting module 701 is configured to set a first switch key and a second switch key on a display interface of the first application and a display interface of the second application, respectively.

The second executing module 702 is configured to perform a switch between the content of the first application and the content of the second application based on the first switch key or the second switch key.

Functions implemented by functional modules according to the embodiments shown in FIG. 5 to FIG. 7 correspond to the steps in the method embodiment, and therefore are not described here repeatedly anymore.

FIG. 8 is a schematic structural diagram of an electronic device 80 according to an embodiment of the disclosure, the electronic device 80 includes at least one processor 801 (for example, CPU), at least one input and output interface 804, a memory 802, and at least one communication bus 803 for implementing connection and communication between the components. The at least one processor 801 is configured to execute computer instructions stored in the memory 802, to make the at least one processor 801 enable to execute the data displaying method according to any one of the foresail embodiments. The memory 802 is a non-transitory memory, and may include a volatile memory such as a high-speed random access memory (RAM), and may also include a non-volatile memory for example at least one magnetic memory. Communicative connection with at least one other device or unit is implemented by at least one input and output interface 804 (which may be a wired communication interface or a wireless communication interface).

In some embodiments, a program 8021 is stored in the memory 802, and the processor 801 is configured to execute the program 8021, to execute the steps in the data displaying method according to any one of the above embodiments.

The electronic device may be implemented in multiple manners, which includes but is not limited to devices as follows:

(1) a mobile communication device which has a mobile communication function, and aims to provide voice communication and data communication. This type of terminal includes a smart phone (for example, iPhone), a multimedia phone, a functional phone, a low-rank phone or the like.

(2) an ultra-mobile personal computer device which belongs to a personal computer, and has a computing and processing function, and also has a characteristic of accessing mobile network. This type of terminal includes a PDA, an MID, a UMPC device, or the like, for example, the iPad;

(3) a portable entertainment device which may display and play multimedia content This type of device includes an audio and video player (for example, iPod), a handheld game machine, an e-book and an intelligent toy and a portable on-vehicle navigation device;

(4) a specific server which provides computing services. The server includes a processor, a hard disk, a memory, a system bus or the like. The server has similar architecture with the general computer, however, the server has high requirements for processing abilities, stability, reliability, security, extensibility and manageability since the server should provide high reliable services; and

(5) other electronic device having a data interactive function.

It should be illustrated that a relation term such as “first” and “second” herein is only used to distinguish one entity or operation from another entity or operation, and does not necessarily require or imply that there is an actual relation or sequence between these entities or operations. Furthermore, terms “include”, “comprise” or any other variations are intended to cover non-exclusive “include”, so that a process, a method, an object or a device including a series of factors not only include the series of factors, but also include other factors not explicitly listed, or also include inherent factors of the process, the method, the object or the device. Without more limitation, a factor defined in a sentence “include a . . . ” does not exclude another same factor in the process, the method, the object or the device including the described factor.

The embodiments in this specification are described in a relative manner. For the same or similar parts between various embodiments, one may refer to the description of other embodiments. Each embodiment lays emphasis on differences from other embodiments.

Since the device embodiment is similar to the method embodiment, the description for the device embodiment is relatively simple. For related parts, reference may be made to description in the method embodiment.

Logics and/or steps represented in the flow chart or described in other manner here may be considered as for example a sequence table for implementing executable instructions of the logic function, which may be implemented in any computer readable medium to be used by an instruction executing system, device or apparatus (for example, a computer-based system, a system including a processor or other system which can read the instructions from the instruction executing system, device or apparatus and execute the instructions), or in conjunction with the instruction executing system, device or apparatus. In the specification, the computer readable medium may be any device which may include, store, communicate with, propagate or transmit the program to be used by the instruction executing system., device or apparatus or in conjunction with the instruction executing system, device or apparatus. The computer readable medium includes for example (a non-exhaustive list), an electrical connector (electronic device) having one or more wires, a portable computer disk cartridge (a magnetic device), a random access memory (RAM), a read only memory (ROM), an erasable programmable read only memory (EPROM or a flash memory), an optical fiber device, and a portable compact disk read only memory (CDROM). In addition, the computer readable medium may even be a paper or other suitable medium on which the program is printed, since optical scanning is performed on the paper or other medium, and editing, decoding or processing in other suitable manner if necessary is performed, to acquire the program in an electronic manner, and the program is then stored in the computer storage.

It should be understood that the parts in the disclosure may be implemented with hardware, software, firmware or a combination thereof

In the above embodiments, multiple steps or methods may be implemented with software or firmware which is stored in the memory and executed by a suitable instruction executing system. For example, when the multiple steps or methods are implemented with the hardware, as similar to another embodiment, the multiple steps or methods may he implemented by any one of the following technologies known in the art or a combination thereof: a discrete logic circuit having a logic gate circuit for implementing logical functions on data signals, a dedicated integrated circuit having a suitable combinational logic gate circuit, a programmable gate array (PGA), and a field programmable gate array (FPGA) or the like.

Only the embodiments of the disclosure are described above, but the protection scope of the disclosure is not limited thereto. Any changes or substitutions readily occurring to those skilled in the art within the technical scope of the disclosure will fall within the protection scope of the disclosure. Therefore, the protection scope of the disclosure should conform to the protection scope of the claims.

1. A data displaying method applied to an electronic device, comprising:
setting a first application having a first display characteristic and a second application having a second display characteristic;
connecting the first application and the second application to a shared database, respectively, the shared database storing display data;
displaying the display data in the shared database on a first screen of the electronic device with the first display characteristic by using the first application; and
displaying the display data in the shared database on a second screen of the electronic device with the second display characteristic by using the second application.

2. The data displaying method according to claim 1, further comprising:
acquiring a first process and a second process respectively corresponding to the first application and the second application; and
creating an inter-process communication connection between the first process and the second process, wherein the inter-process communication connection is configured to acquire the display data of the first application or the second application.

3. The data displaying method according to claim 2, further comprising:
acquiring current display content of the first application on the basis of the inter-process communication connection;
determining whether the current display content of the first application has the second display characteristic;
acquiring display information corresponding to the current display content of the first application by using the second application when the current display content of the first application has the second display characteristic; and
displaying the display information corresponding to the current display content of the first application on the second screen of the electronic device with the second display characteristic.

4. The data displaying method according to claim 3, wherein the display information comprises at least one of:
ID of a reading file corresponding to the current display content of the first application; and
reading progress information of the reading file corresponding to the current display content of the first application.

5. The data displaying method according to claim 4, the acquiring the display information corresponding to the current display content of the first application by using the second application comprises:
reading, from the shared database by using the second application, at least one of the ID and the reading progress information of the reading file corresponding to the current display content of the first application which is stored in the shared database.

6. (canceled)

7. The data displaying method according to claim 1, further comprising:
setting a first switch key and a second switch key on a display interface of the first application and a display interface of the second application, respectively;
displaying the content of the first application by the second application in response to a switch instruction of the first switch key or the second switch key; or
displaying the content of the second application by the first application in response to a switch instruction of the first switch key or the second switch key.

8. The data displaying method according to claim 1, wherein
the display data of the shared database comprises reading texts in different data formats.

9. The data displaying method according to claim 8, wherein the displaying the display data in the shared database on the first screen of the electronic device with the first display characteristic by using the first application comprises:
analyzing the reading texts stored in the shared database by using the first application; and
displaying the reading texts on the first screen.

10. The data displaying method according to claim 8, wherein the displaying-the display data in the shared database on a second screen of the electronic device with the second display characteristic by using the second application comprises:
acquiring the reading texts stored in the shared database;
determining whether the formats of the reading texts are compatible with the second application;
analyzing, in the second application, the reading texts compatible with the second application; and
displaying, on the second screen, the reading texts compatible with the second application.

11. An electronic data displaying device, comprising:
one or more processors; and
a memory;
wherein one or more instructions are stored in the memory, and when executed by the one or more processors, the one or more instructions cause the one or more processors to:
set a first application having a first display characteristic and a second application having a second display characteristic;
connect the first application and the second application to a shared database, respectively, the shared database storing display data;
display the display data in the shared database on a first screen of the electronic device with the first display characteristic by using the first application; and
display the display data in the shared database on a second screen of the electronic device with the second display characteristic by using the second application.

12. The electronic device according to claim 11, wherein the one or more processors are further caused to:
acquire a first process and a second process respectively corresponding to the first application and the second application; and
create an inter-process communication connection between the first process and the second process, wherein the inter-process communication connection is configured to acquire the display data of the first application or the second application.

13. The electronic device according to claim 12, wherein the one or more processors are further caused to:
acquire current display content of the first application on the basis of the inter-process communication connection;
determine whether the current display content of the first application has the second display characteristic;
acquire display information corresponding to the current display content of the first application by using the second application when the current display content of the first application has the second display characteristic; and
display the display information corresponding to the current display content of the first application on the second screen of the electronic device with the second display characteristic.

14. The electronic device according to claim 13, wherein the display information comprises at least one of:
ID of a reading file corresponding to the current display content of the first application; and
reading progress information of the reading file corresponding to the current display content of the first application.

15. The electronic device according to claim 14, wherein the one or more processors are further caused to:
read, from the shared database by using the second application, at least one of the ID and the reading progress information of the reading file corresponding to the current display content of the first application which is stored in the shared database.

16. (canceled)

17. The electronic device according to claim 11, wherein the one or more processors are further caused to:
set a first switch key and a second switch key on a display interface of the first application and a display interface of the second application, respectively; and
perform a switch between the content of the first application and the content of the second application on the basis of the first switch key or the second switch key.

18. The electronic device according to claim 11, wherein the display data of the shared database comprises reading texts in different data formats.

19. The electronic device according to claim 18, wherein the one or more processors are further caused to:
analyze the reading texts stored in the shared database by using the first application; and
display the reading texts on the first screen.

20. The electronic device according to claim 18, wherein the one or more processors are further caused to:
acquire the reading texts stored in the shared database;
determine whether the formats of the reading texts are compatible with the second application;
analyze, in the second application, the reading texts compatible with the second application; and
display, on the second screen, the reading texts compatible with the second application.

21. (canceled)

22. A non-transitory computer readable memory medium in which computer instructions are stored, wherein the computer instructions enable a computer to execute the following steps:
setting a first application having a first display characteristic and a second application having a second display characteristic;
connecting the first application and the second application to a shared database, respectively, the shared database storing display data;
displaying the display data in the shared database on a first screen of the electronic device with the first display characteristic by using the first application; and
displaying the display data in the shared database on a second screen of the electronic device with the second display characteristic by using the second application.

23. (canceled)
